(19) United States
(12) Patent Application Publication
(10) Pub. No.: US 2021/0144960 A1
(43) Pub. Date: May 20, 2021

(54) Automatic pet feeder with cooler

(71) Applicant: Bruce Anurag Taneja, Naperville, IL (US)

(72) Inventor: Bruce Anurag Taneja, Naperville, IL (US)

(21) Appl. No.: 16/686,112

(22) Filed: Nov. 16, 2019

(51) Int. Cl. A01K 5/01; A01K 5/02; A01K 7/02

(52) U.S. Cl. CPC A01K 5/0114; A01K 7/027; A01K 5/0291

(57) ABSTRACT

An automatic pet feeder with cooler has a compartmentalized serving tray and a thermoelectric cooling peltier device with a condensation collector. The tray rotates inside an insulated enclosure with an opening just sufficient to expose food from one of the compartments on the tray for household pets. The wet pet food in remaining enclosed compartments is kept at a cold temperature, similar to a refrigerator, thereby preventing bacterial spoilage of pet food over a longer time periods. Since the thermoelectric cooling peltier device surface cools down below ambient temperature, condensation forms on it and drips down into the condensation collector where it is channeled to away where it can evaporate. Using an included user interface, a human user of the device can enter the times when the serving tray should rotate such as to expose one of the various enclosed food compartments on the serving tray for a household pet. This exposed compartment allows a pet to eat from this automatic pet feeder without requiring presence of a human user at the time the pet needs to be fed wet food.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of automated pet food dispensers. More particularly, the present invention is in the technical field of dispensing of wet food to household pets. There have been a number of inventions in automated and timed dispensing of pet food for pets like dogs and cats, as often pet owners need to leave their homes for work or for a weekend and need their pets fed when they are gone.

“Wet” food for dogs and cats typically refers to wet or moist food from pet food cans or could be a home-prepared high moisture meal by a pet owner. Such food is termed “wet” to distinguish it from commercially available “dry” pet food sold in sealed bags. Such wet food is susceptible to spoilage due to bacteria growth when left open at room temperature. In comparison, dry food has very low moisture content and will not decay for extended periods without refrigeration.

Most inventions on the market work well only for dispensing dry pet food. However, a significant percent of pet owners prefer wet food since dry food contains very little moisture, which can lead to dehydration in pets, which can possibly lead to various health issues. Further, a significant percent of pets prefer wet or moist food versus dry food.

Almost all current inventions on the market that dispense wet or moist canned food, require the pet owner to place an ice pack inside the dispensing unit to keep the food cold to preserve the freshness. However, such ice packs lose effectiveness in 24 hours or less as they warm up to the room temperature in a few hours.

In comparison, this invention has an electrically powered cooler similar to a refrigerator in order to preserve the wet food from decaying prior to dispensing and the use of ice packs is not required. Both wet food and dry food can be served with this invention, however, due to the advantage of the cooler built-in, a typical user of this device will primarily use this device to dispense wet food to their pet(s).

### REFERENCES CITED

### U.S. Patent Documents

| PATENT | Dated | Inventor | Limitations of Prior Art: |
|---|---|---|---|
| US-2008/0289580 A1 | January 2010 | Krishnamurthy | Wet food gets exposed to airborne bacteria and |
| | | | decays quickly |
| US-2005/0066905 A1 | March 2005 | Morosin et. al. | Wet food loaded will go bad after ice packs have |
| | | | stopped providing sufficient cooling. Limited |
| | | | loading capacity. |
| W02000074474 A1 | June 1999 | Alan John Springett | Automatic animal food dispenser with cooling; |
| | | | requires a cutter and mechanical controls to |
| | | | dispense food; cutting blade can get contaminated |
| WO 2017/185053 Al | October 2017 | BUSICK, | Single compartment cooling dispenser for water |
| | | MCCURDY, et al. | only. |
| U.S. Pat. No. | May 2007 | Sundararajan | Wet food loaded will go bad after ice packs have |
| 7,650,855B2 | | Krishnamurthy | stopped providing sufficient cooling. Limited |
| | | | loading capacity. |

Prior Art Limitations: None of the prior arts provide electrically powered cooling of wet food prior to dispensing in order to preserve the freshness of wet pet food over 24 hours, except one. This only exception is WO2000074474 A1 by Springett, which requires a cutting blade, which can get contaminated with bacteria after its first use unless the machine cleans the blade or the blade itself is maintained at a sufficiently cold temperature. Unfortunately, this does not appear to be the case in this invention.

### SUMMARY OF THE INVENTION

The present invention relates to an automatic pet food dispenser, which consists of an insulated base, an insulated cover, both of which form an enclosure. Inside this enclosure is a rotatable serving tray with multiple food compartments. The user (owner) of the device can fill these compartments with food of their choice for their pet(s). The insulated cover has an opening, which exposes one of these food compartments and thus allows pets such as dogs or cats to eat food from the exposed food compartment. The compartmentalized serving tray is connected to a motor that rotates the serving tray as needed to expose different food compartments under the opening of the cover that allows for serving of food at preconfigured times to a pet.

Further, there is a thermoelectric cooling (TEC) peltier device with a cooling finned plate also known as a heat sink, and a fan mounted inside the enclosure or on this finned plate formed by the insulated cover and insulated base. The fan circulates the air within the unit and forces the air to flow over the finned surface cooled by thermoelectric cooling peltier device, which then cools the air. This cool air, in turn, cools down the food as the air flows over the compartments containing the food. By keeping wet food cold, this invention preserves the freshness of the food and prevents the food from going bad due to bacterial growth over an extended period just like a refrigerator. This invention therefore allows the pet to be fed with controlled portions of wet food without human intervention over longer time periods than would be possible otherwise due to bacterial food spoilage.

### BRIEF DESCRIPTION OF THE DRAWINGS

FIG. 1 is a perspective view of front left side of the present invention with cover closed.

FIG. 2 is a perspective view of front left side of the present invention with cover open.

FIG. 3 is a perspective view of front higher left side of the present invention with cover open such that the user interface such as LCD and food dispenser timings input buttons are seen more clearly.

FIG. 4 is a perspective view of the rear of unit showing multiple vents from where heat exchanger releases heat.

FIG. 5 is a perspective view of front left side of the present invention with some of the components seen exploded.

FIG. 6 is a perspective view of front left side of the air-cooled thermoelectric cooler assembly in more detail.

FIG. 7 is a perspective view of rear left side of the air-cooled thermoelectric cooler assembly in more detail.

FIG. 8 is a perspective view showing exploded components with TECC—alternate cooling device

FIG. 9 is a perspective view of front left side of the liquid-cooled thermoelectric cooler assembly in more detail.

FIG. 10 is a perspective view of rear left side of the liquid-cooled thermoelectric cooler assembly in more detail.

### PARTS REFERENCE LIST

ICT Insulated Cover

INS Insulation layer

INC Inside Cover layer

ICO Insulated Cover Opening

IBB Insulated Base

CC Condensation Collector

CST Compartmentalized Serving Tray

FC Food Compartment (7 Compartments shown in CST)

EFC Exposed Food Compartment

TECS1 Thermoelectric Cooler #1 (also referred or just a thermoelectric cooler in case only one such cooler is installed).

TECS2 Thermoelectric Cooler #2

TECS3 Thermoelectric Cooler #3

TECFIN1 Thermoelectric Cooler Finned Plate #1

TECFIN2 Thermoelectric Cooler Finned Plate #2

TECFIN3 Thermoelectric Cooler Finned Plate #3

TEC1 Thermoelectric Cooler [Peltier] device #1 (also referred to as thermoelectric cooler device; also just referred to as thermoelectric cooler peltier device)

TEC2 Thermoelectric Cooler [Peltier] device #2

TEC3 Thermoelectric Cooler [Peltier] device #3

TECC Thermoelectric Cooler [Peltier] device (as an alternate cooling source of Food compartment(s)). (Optional)

TECH Thermoelectric Cooler [Peltier] device (in reversed orientation for heating of served food from under Exposed Food Compartment). (Optional)

TECF1 Thermoelectric Cooler Fan #1

TECF2 Thermoelectric Cooling Fan #2

TECF3 Thermoelectric Cooling Fan #3

HEFIN Heat Exchanger Finned Plate

HEXF1 Heat Exchanger Fan #1

HEXF2 Heat Exchanger Fan #2

HEXF3 Heat Exchanger Fan #3

PCB PCB with microcontroller and WiFi adapter

LCD LCD screen display interface

INP Input interface

MOT Motor to rotate serving tray

MOTG Motor gear assembly

VENT Vents to allow release heat

PWR 12V Power Adapter

RHOU Rear Housing

RADIATOR Liquid cooled radiator

TUBING1 Tubing from TANK to RADIATOR

TUBING2 Tubing from RADIATOR to PUMP

TUBING3 Tubing from PUMP to TANK

PUMP Liquid pump to force circulation for cooling via RADIATOR

TANK Tank liquid container which allows liquid to absorb heat

### DETAILED DESCRIPTION OF THE INVENTION

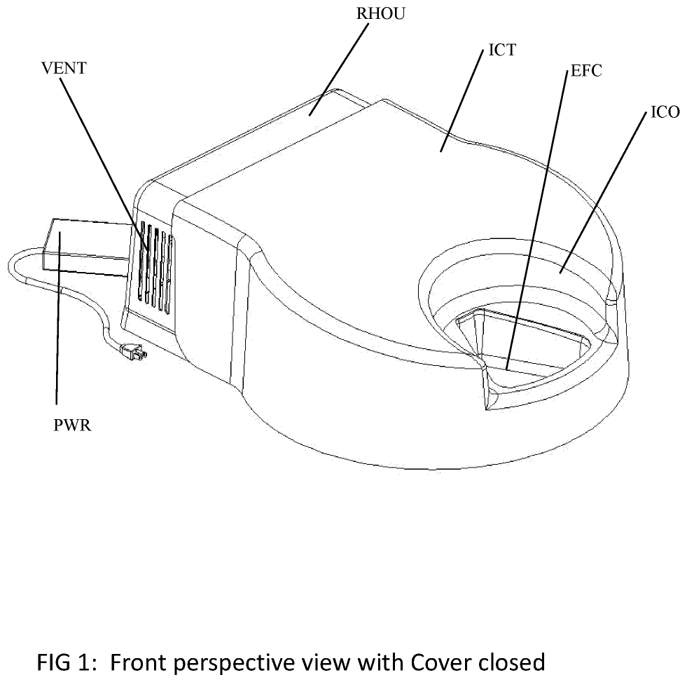

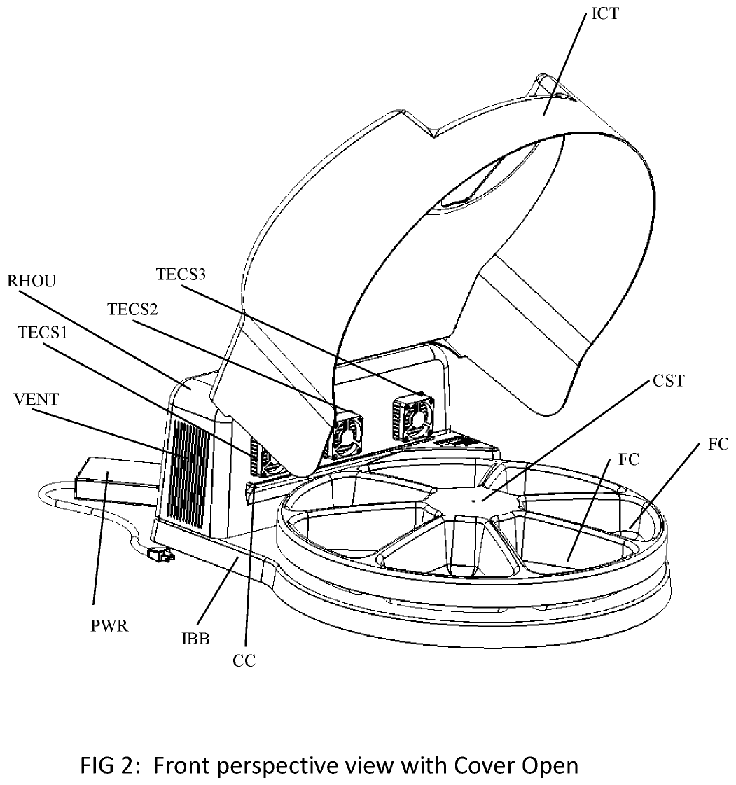

Referring now to the invention in more detail, in FIG. 1 and FIG. 2, shown is the pet feeder perspective views, with the insulated cover on top (ICT) closed and insulated cover ICT open. We also see the insulated base (IBB). When the ICT insulated cover is open, the Compartmentalized Serving Tray (CST) is seen with all food compartments (FC) clearly. When ICT cover is closed, we see only one food compartment of CST tray exposed, this food compartment is referred to as the exposed food compartment (EFC).

Typically, the owner (user) of the device will first open the cover. Then the user will load predetermined wet (canned or moist) or dry processed food portions into various compartments, program the unit via the interface to dispense food at various times, and close the cover such that only the exposed food compartment EFC is accessible to a pet. A pet can start eating food from this EFC compartment right away. At the next pet feeding time programmed by the user, the CST tray will rotate as explained further below so that the next food compartment is exposed for a pet to eat food from. This cycle of exposing further food compartments to a pet repeats as programmed by the owner (user) of the device.

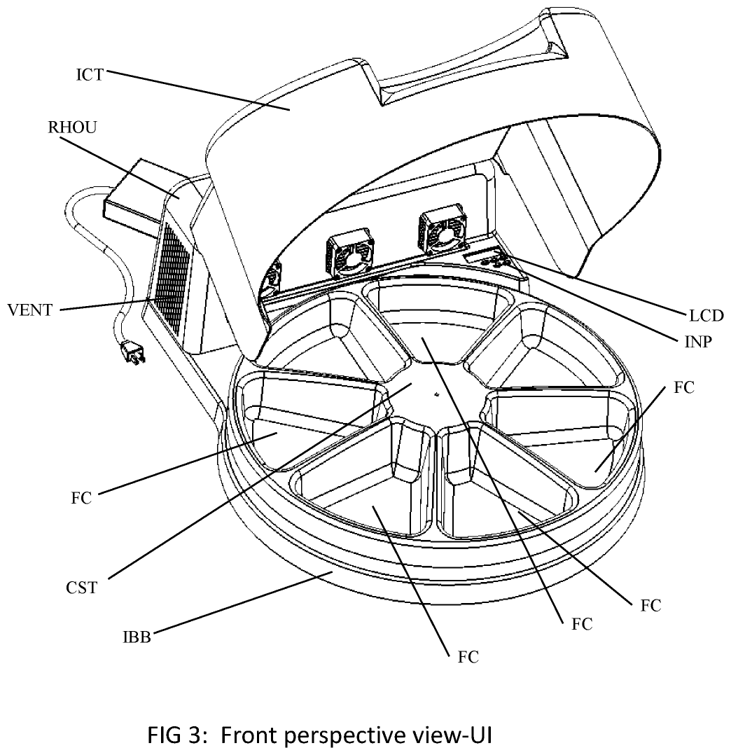

FIG. 3 shows the user interface consisting of an LCD information display panel as well as buttons to input programming for various times the next food compartments should be exposed to a pet. Instead of having a small LCD screen and buttons as shown, this invention could be equipped with a small touch screen LCD to show information as well as accept input programming.

Further, in FIG. 1, FIG. 2 and FIG. 3, we also see multiple thermoelectric coolers: TECS1, TECS2, and TECS3 as means to provide cold circulating air inside the insulated pet feeder enclosure formed between the insulated cover ICT and insulated base IBB. Note that a minimum of only one thermoelectric cooler TECS1 is required to operate this unit, however, additional thermoelectric coolers are added in this invention to provide faster cooling as well as redundancy in case one of the thermoelectric coolers fail over time. The cold air from the thermoelectric cooler(s) preserves the wet pet food in the various food compartments (FC) from bacterial spoilage by reducing the temperature of the food. There are seven FC food compartments shown on the compartmentalized serving tray CST, however, design of such a tray could contain anywhere from just two large food compartments to fifteen small food compartments depending on users' needs. Multiple such compartmentalized serving trays CST could be provided with the unit, which can be switched by the user based on their needs.

Also seen in the above figures is a power supply PWR, which provides sufficient power in terms of voltage and current to operate the device. This power supply is optimally a 12V, 15 amp power supply, however, this device can be easily fitted with high power tolerances and could operate at as low as 5V, 4 amp and as high as 24V, 20 amps and all other configurations in between. Lower voltages below 12V will generate lower amounts of cooling and higher voltages above 12V will generate more cooling, but such higher voltages will also reduce the life of the thermoelectric cooler. Therefore, we have selected the optimal 12V, 15 amp power supply for now.

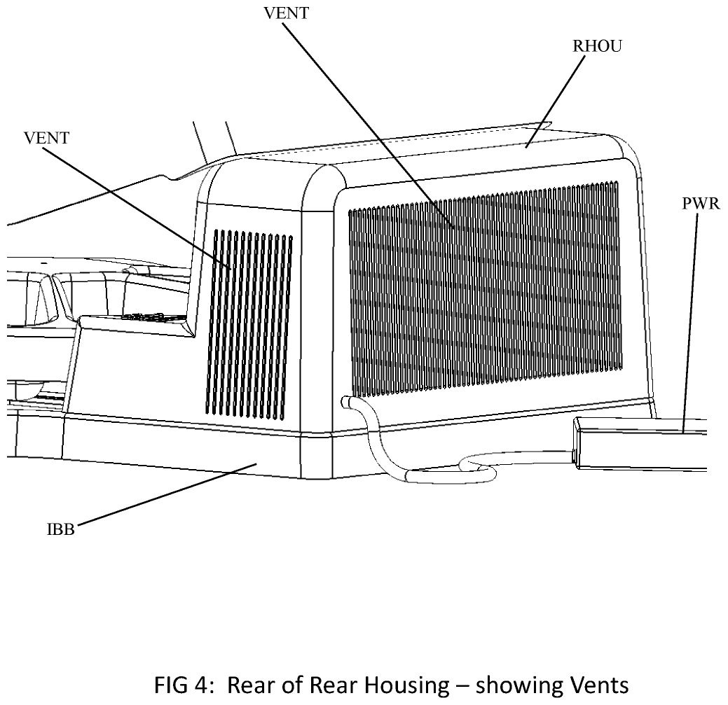

When the thermoelectric cooler operates, it removes heat from the inside of the pet feeder's insulated enclosure and radiates the heat outside from the rear of the unit where the multiple vents (VENT) are located. See FIG. 3, FIG. 4 for VENT locations on the rear housing RHOU.

The optional rear housing RHOU encapsulates the thermoelectric cooler(s) in order to protect the fans from external objects and to protect external objects including the user and pets from the heat exchanger's fans. Rear housing RHOU also adds aesthetics to the invention. The LCD & INP user interface could be integrated into the insulated base IBB component if RHOU is removed from this design.

Further, the LCD & INP user interface itself is optional as the PCB is optionally equipped with a WiFi adapter so the user can use a remote device such as a computer or a smartphone as the user interface to view status and input food compartment dispense times.

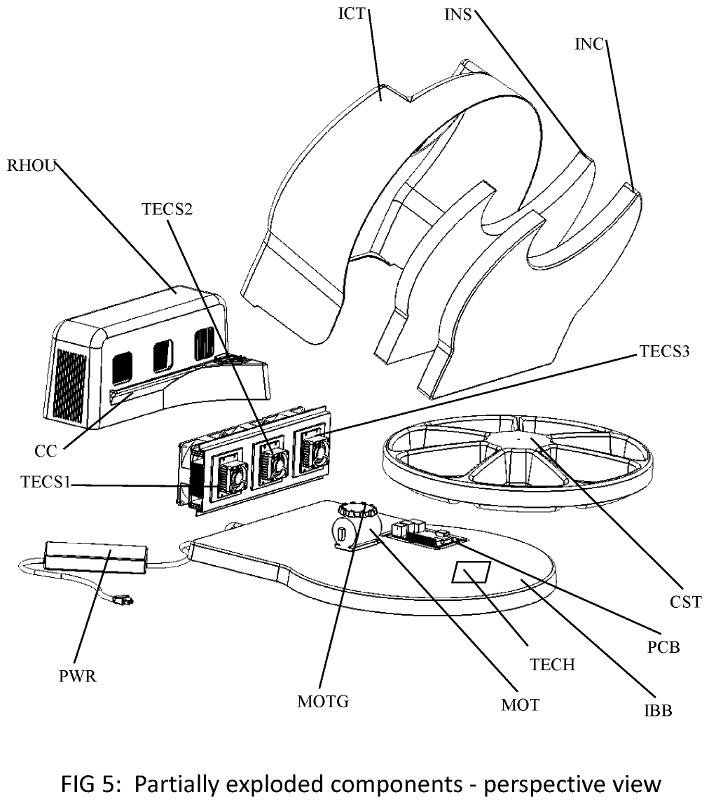

Referring now to FIG. 5, we see an exploded view of some of the components. Below the compartmentalized serving tray CST, we see the motor MOT, and motor gear extension MOTG. MOTG engages the compartmentalized serving tray CST and causes it to rotate as needed such that the next food compartment is exposed under the insulated cover ICT's opening ICO as seen in FIG. 1, thereby making food in the now exposed food compartment EFC also as in FIG. 1 accessible to a pet.

Referring again to FIG. 5, we see the printed circuit board PCB that also hosts a microcontroller and an optional WiFi adapter. The microcontroller is programmed with a logic that helps it control the movements of the motor MOT to turn serving tray CST as needed for the operation of this device. The optional WiFi adapter allows a user to connect this device to their home WiFi such that this device is able to send and receive data over the network and internet as desired. This allows the user to connect a device like a computer and a smartphone to interface with the device as described earlier and receive data such as time of last food dispense and time of next dispense.

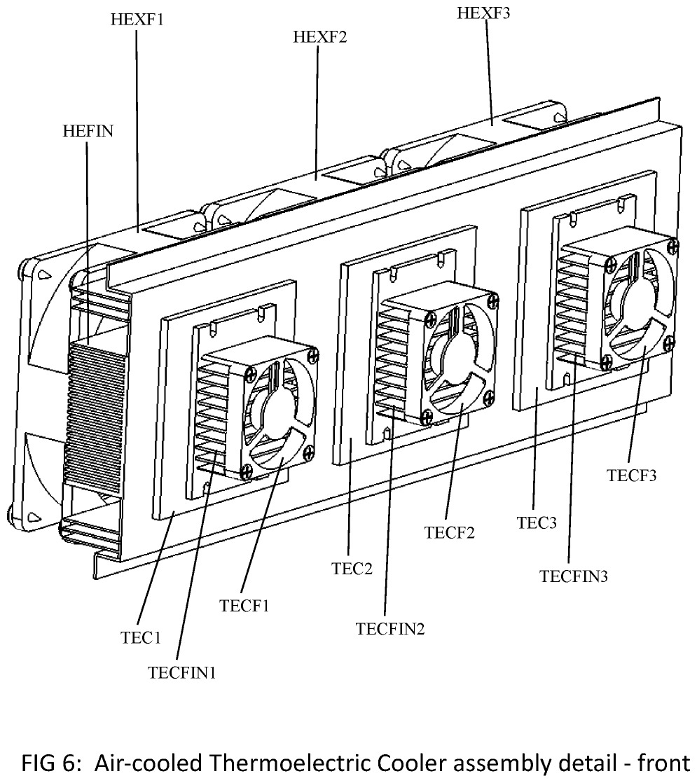

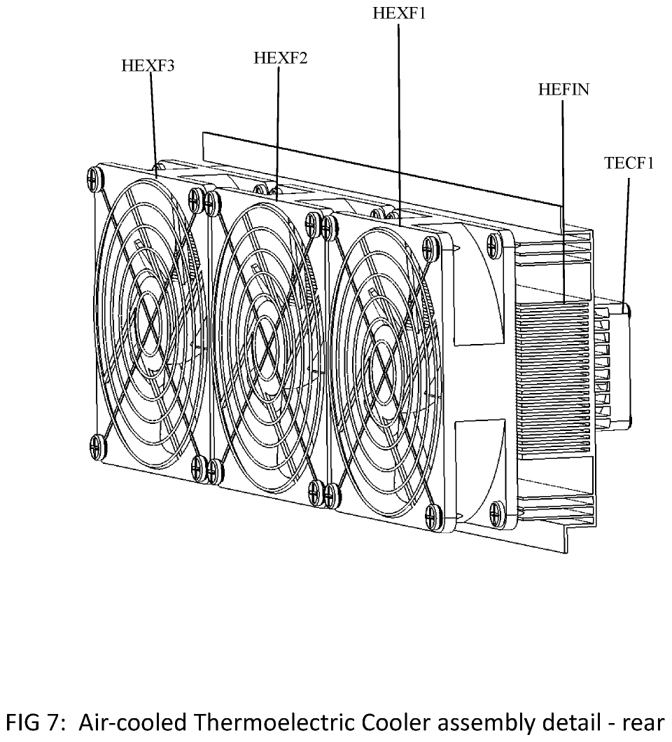

Now referring to FIG. 6 & FIG. 7, which are the front and rear perspective views of the thermoelectric cooler assembly in detail. We will now discuss the assembly and working of this thermoelectric cooler. In the current device, a minimum of one thermoelectric cooler such as TECS1 is required. The current invention will optimally run with three thermoelectric coolers as shown labeled as TECS1, TECS2, and TECS3. Each of these coolers contains a thermoelectric cooler peltier device such as TEC1, TEC2, TEC3. The thermoelectric cooler peltier device is usually in the shape of a small 80 mm×80 mm plate that is about 9 mm thick. When this thermoelectric cooler peltier device is supplied sufficient power (usually 12V, 5 amps), the thermoelectric cooler peltier device removes heat from one side of the thermoelectric cooler peltier device and expels heat from the other side of the thermoelectric cooler peltier device. This heat must be quickly dissipated, else, the heat transfer function cannot work optimally and the cool side will not cool down sufficiently enough needed to keep the pet food cool enough. For optimal results, we have a few options. For example, on the hot side of the thermoelectric cooler peltier device, we can mechanically bond a heat exchanger plate with fins (HEFIN) using screws and threaded bolts to the thermoelectric cooler peltier device(s). The hot side of the thermoelectric cooler peltier device then transfers the heat to the HEFIN component. These fins increase the surface area from which heat can be radiated, making the heat radiation process more efficient. Further, we mechanically attach a minimum of one fan, and in case of this device optimally three fans are known as the heat exchanger fans (HEXF1, HEXF2, HEXF3) onto the HEFIN plate using screws. These heat exchanger fans could also powered via the power adapter PWR or via an optional battery. These heat exchanger fans pull in cool outside air via the rear vents (VENT), force the air through the hot fins which are absorbing heat from the thermoelectric cooler peltier devices such as TEC1, TEC2, TEC3. The hot air then exits via the vents VENT shown on the sides of the rear housing RHOU.

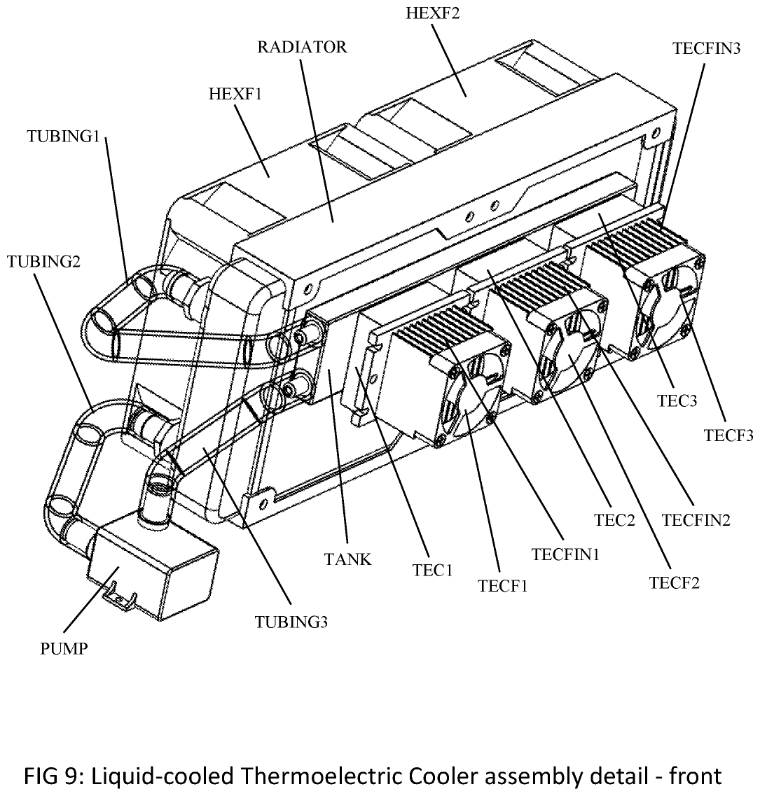

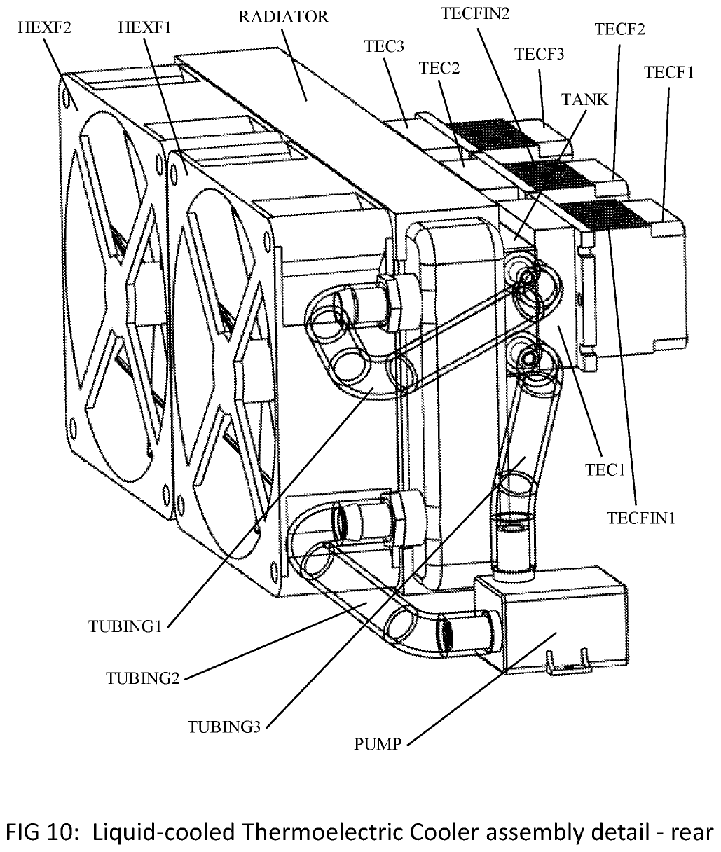

Now referring to FIG. 9 & FIG. 10, please note that the heat exchanger can optionally be built with a radiator (RADIATOR) as shown where water or another liquid is used as a coolant instead of utilizing an air cooling based method as described earlier. Such a liquid-based cooling system would be similar to the ones used in many computers that circulate water or coolant via fins based radiator to cool down a hot computer processor. Such a liquid cooler is more expensive to build and maintain, however, it is more effective than air-based cooling. In this method, we utilize a liquid tank (TANK) that is compressed against the hot side of the thermoelectric cooler peltier device(s), such as TEC1, TEC2, TEC3, whereby heat is absorbed by the liquid in the tank (TANK). A pump (PUMP) circulates liquid from the tank (TANK) to the radiator (RADIATOR) via a tubing (TUBING1), where the fan(s) such as HEXF1, HEXF2 blow air through the radiator, resulting in cooling of the liquid. Such tubing could be made of plastic, silicone, nylon, PVC, or another suitable material capable of transferring water. The cooled liquid is then pulled in from the radiator by the pump (PUMP) via tubing TUBING2 and then pushed by the pump back into the tank (TANK) for the next heat exchange cycle via tubing TUBING3. It should be noted that a commonly used liquid cooling radiator for cooling computer processors can be utilized in this application.

On the cold side of the mentioned thermoelectric cooler peltier device such as TEC1, TEC2, TEC3, we use a similar setup as discussed above in order to optimize the cooling effects. The various optional thermoelectric cooling finned plates such as TECFIN1, TECFIN2, TECFIN3 are mechanically or chemically glued to the thermoelectric cooler peltier devices (TEC1, TEC2, TEC3) to allow faster transfer of cold temperature to the fins mentioned. These fins increase the surface area from which cold temperature can be radiated, making the distribution of cold temperature more efficient. Further, we chemically or mechanically bond cooling fans TECF1, TECF2, TECF3 on the thermoelectric cooling finned plates TECFIN1, TECFIN2, TECFIN3. These fans force circulation of the air within the enclosure of the current pet feeder invention and also force the air to pass over the thermoelectric cooling finned plates TECFIN1, TECFIN2, TECFIN3 thereby cooling down the air inside the pet feeder even faster and more efficiently. This cold air, in turn, will cool down the pet food, which helps preserve the freshness of the pet food, much like a refrigerator. All food compartments except for the one which is exposed, are insulated inside the pet feeder and cold temperature is maintained around the food which is not dispensed yet. The exposed food compartment in which the food is served to the pet is not enclosed and therefore starts to warm up to room temperature when the food bowl is exposed to room temperature air, outside this pet feeder enclosure.

In normal operation, ice can form on thermoelectric cooling finned plates TECFIN1, TECFIN2, TECFIN3 as well as the cold side of the thermoelectric cooling devices TEC1, TEC2, TEC3. Please note that thermoelectric cooling devices TEC1, TEC2, TEC3 cold side temperature can range between 40 F to −10 F degrees. Since this surface is cooler than the ambient air temperature, some of the moisture in the air will condense on the surface of the cooling finned plates. In scenarios where the cooling finned plate temperature is below freezing, the condensation will turn into ice. After some time, when the air temperature inside this pet feeder reaches sufficiently cold temperatures, similar to a refrigerator, e.g. 40 degrees Fahrenheit, an optional thermostat could signal to the microcontroller to turn off the power to the thermoelectric cooling devices TEC1, TEC2, TEC3. As these thermoelectric cooling finned plates attached to the thermoelectric cooling devices warm up to above-freezing temperature, the ice on the finned plates will start to melt and corresponding water drips into the below-located condensation collector CC. This condensation collector CC can be in shape of an indented tray or an absorbent sponge where such water can be captured instead of dripping inside on to the insulated base IBB, thereby dripping into food compartments changing the composition of the water content in the pet food. Such condensed water could also leak to outside of the unit on to the floor. Many pets and pet owners might find such leakages undesirable. A small optional outlet can help this drain this water out from inside of the insulated pet feeder area, and to another tray-like area, but at warmer, room temperature, where it will evaporate over time. Alternatively, the user of the device can clean out this collected condensation using a towel at a convenient time such as when refilling food compartments.

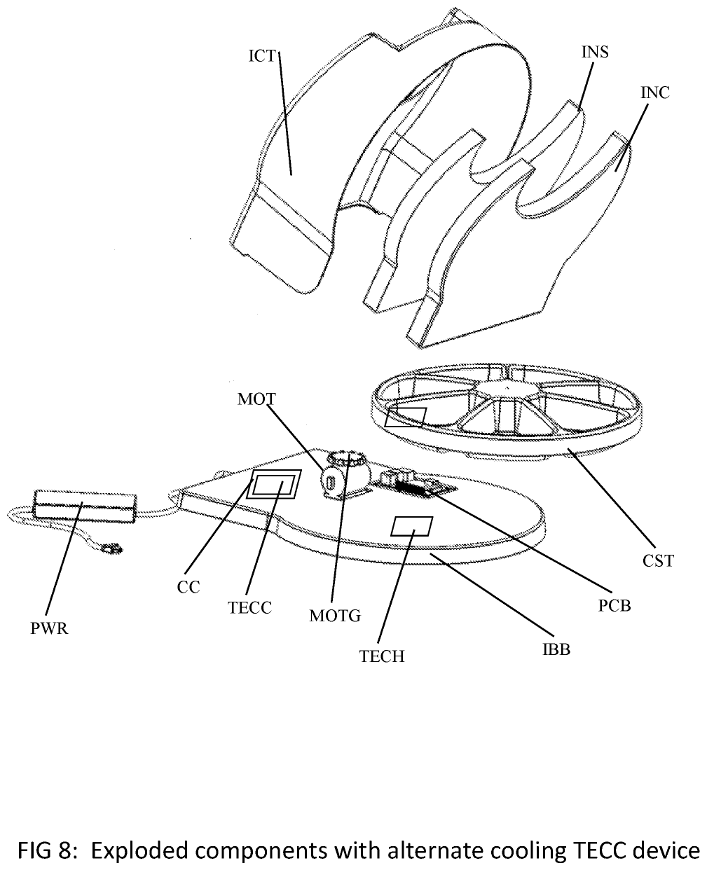

An alternate method of cooling down pet food is via conduction where one or more thermoelectric cooler peltier devices e.g. TECC as shown in FIG. 8, could be installed on the insulated base IBB with cold side up against the compartmentalized serving tray, such that they cool down the food compartments and the food within via conduction. We would optionally want to have a heat exchanger to release heat from under IBB to keep the thermoelectric cooler peltier device's cooling efficient. Overall, this method is not as optimal as the previous methods discussed, as, in this method, the food compartment and food would cool down faster than the air inside this insulated pet feeder unit. This will result in a higher level of water from condensation collecting into the food bowls, which is not desirable. However, this method would also work fine, albeit with some extra moisture in pet food.

Further, when a new food bowl is exposed to a pet for feeding, some pets and users prefer that the food be brought to room temperature quicker. Therefore an optional thermoelectric cooler peltier device TECH reversed, i.e., with the hot side up and cold side down can be installed under the exposed food compartment EFC. When food is served, this thermoelectric cooler peltier device with hot side touching the food compartment can be supplied power via a relay controlled by a signal from the microprocessor. This thermoelectric cooler peltier device will then start to warm up the served food in exposed food compartment EFC quicker than what could be achieved by just plain exposure of cold food to room air.

The dimensions of this unit can typically vary depending on various insignificant alterations in the design such as the position of thermoelectric cooler assembly, selected number of thermoelectric coolers, aesthetics of various parts, volume of air gaps, and the desired size of food compartments which can also change the amount of food fed to a pet. Such a unit would approximately have length×breadth range from [12-inch×12-inch] to [24-inch×24 inch] and does not necessarily have to square-shaped. The height of the unit can typically be 2-inches to 10-inches and further, the unit may not be of uniform height all throughout. Height is determined on the lowest end by the desired height of the exposed food compartment EFC so a pet can easily access the food. On the t end of the unit, height is determined by the orientation and height of the heat exchanger fans selected which also determines the height of the optional rear housing.

While most custom-made parts of this invention, including rear cover, insulated base, insulated cover and compartmentalized serving tray would likely be plastic injection molded, it is possible to make these in other materials such as various metal alloys. The insulation layer INS, as shown in FIG. 5, can be made of foam or reflective insulation material, or just vacuumed double-walled between the insulation cover ICT layer and inside insulation cover INC layer. Similarly, an insulation layer is needed within the double-walled insulated base IBB layer.

Some pet owners prefer their pets to eat of metal bowls made from materials such as stainless steel instead of injection-molded plastic. Usually, such preference is driven by the fact that the plastic food compartments can harbor microscopic bacteria, which is difficult to get rid of even after thoroughly washing the plastic compartmentalized serving tray. Further, eating out of such infected plastic materials sometimes results in an infectious chin disease in cats since their chins repeatedly touch the plastic compartment during feedings. To prevent this problem, custom-made stainless steel inserts could be placed inside the food compartments. Such inserts would be sold as part of the invention. Stainless steel inserts clean much better and thereby prevent such health issues.

As seen in FIG. 1, the insulation cover opening ICO allows a pet to reach into the invention and eat food from one of the food compartments. The opening ICO is sized such that it is approximately the same size as the food compartment and so that pets have access to exactly one food compartment at a time. Another consideration for this opening is that it needs to be fairly tight against the top edges of the food compartment it aligns with. This is to minimize cool air escaping out from inside the insulated pet feeder enclosure. If the loss of cool air is significant and the room temperature is significantly hot, this invention will have difficulty keeping the pet food cold in the non-exposed food compartments. While this can be achieved by designing the insulated cover opening edges to be close against the serving tray, an optional gasket could also be mounted on the inside edges of the insulated cover opening to further minimize the loss of cool air.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

I claim:

1. An automatic pet food feeder, comprising
a) a serving tray with predetermined number of compartments means to contain pet food to be served at predetermined times from each of the compartments,
b) an insulated enclosure for enclosing said serving tray means for maintaining temperature of said pet food,
c) at least one thermoelectric cooler device means for cooling said pet food,
d) at least one condensation collector, means to collect condensation formed due to cooling of said thermoelectric cooler device,
e) an opening on said insulated enclosure means to expose one of said compartments further means for pet to access said pet food,
f) an electrically powered motor,
g) at least one elongated element which transfers rotatory movement of said motor to said serving tray means for rotating said serving tray to predetermined positions,
h) a programmed microcontroller commanding said motor's rotation,
whereby said pet food will be served at predetermined times without any human presence required.

2. The automatic pet feeder of claim 1, wherein said insulated enclosure comprises an insulated base and an insulated cover.

3. The automatic pet feeder of claim 2, wherein there is a sufficient gap between said insulated cover and said serving tray to allow air to circulate over said enclosed compartments.

4. The automatic pet feeder of claim 3, wherein said thermoelectric cooler device further mounted with at least one metal plate with fins means to cool air faster.

5. The automatic pet feeder of claim 4, wherein said metal plate with fins further mounted with at least one fan means to cool air faster.

6. The automatic pet feeder of claim 2, wherein said motor mounted on said insulated base.

7. The automatic pet feeder of claim 2, wherein said motor mounted on said insulated cover.

8. The automatic pet feeder of claim 1, wherein said thermoelectric cooler device further mounted with a heat exchanger means to remove heat to outside of said pet feeder.

9. The automatic pet feeder of claim 8, wherein said heat exchanger further includes at least one metal plate with fins means to release heat faster to outside of said pet feeder.

10. The automatic pet feeder of claim 9, wherein said metal plate with fins further mounted with at least one fan means to release heat faster to outside of said pet feeder.

11. The automatic pet feeder of claim 8, wherein said heat exchanger further includes a tank filled with liquid, which is further connected to a radiator with at least two pipes and at least one pump means for circulating liquid from said tank to said radiator means for cooling down said liquid.

12. The automatic pet feeder of claim 1, wherein said at least one thermoelectric cooler device is installed under at least one said compartment means to cool down said food in said compartment via conduction.

13. The automatic pet feeder of claim 1, wherein said condensation collector drains condensation to outside insulated enclosure where said condensation evaporates over time via convection.

14. The automatic pet feeder of claim 1, further including a power adapter, means for supplying sufficient electrical power to operate said thermoelectric cooler, said motor and said microcontroller.

15. The automatic pet feeder of claim 1, further including a battery, means for supplying backup electrical power to operate said motor and said microcontroller.

16. The automatic pet feeder of claim 1, further including a user interface display device means for displaying status comprising current time and time when next said compartment would be served.

17. The automatic pet feeder of claim 1, further including buttons connected to said microcontroller means for user to enter time period next said compartment be served.

18. The automatic pet feeder of claim 1, further including touch screen connected to said microcontroller means for a user to enter when various said compartments be served.

19. The automatic pet feeder of claim 1, further including a wireless network adapter means for transmitting device status and receiving commands means to configure food serving times from an external source such a smart phone controlled by user.

20. The automatic pet feeder of claim 1, wherein said compartments allow metal bowl inserts means for serving pet food in metal bowls.
